(19) United States
(12) Patent Application Publication
(10) Pub. No.: US 2026/0198610 A1
(43) Pub. Date: Jul. 16, 2026

(54) COMMUNICATION DEVICE

(71) Applicant: NICOVENTURES TRADING LIMITED, London (GB)

(72) Inventors: Darryl BAKER, London (GB); Najeeb YOUNOSSI, London (GB); Roberto PELLEGRINI, London (GB)

(21) Appl. No.: 19/134,802

(22) PCT Filed: Nov. 30, 2023
(86) PCT No.: PCT/EP2023/083797

§ 371 Date: Jun. 2, 2025

(30) Foreign Application Priority Data
Dec. 2, 2022 (GB) 2218154.9

(51) Int. Cl. A24F 40/65; H04W 4/02

(52) U.S. Cl. CPC A24F 40/65; H04W 4/023

(57) ABSTRACT

There is provided a stationary communication device for communicating to an aerosol provision device, the stationary communication device comprising: a housing; a communication module housed in the housing, arranged for communication with the aerosol provision device; and, storage for storing data relating to the aerosol provision device.

### TECHNICAL FIELD

The present invention relates to a stationary communication device, a system, and an arrangement.

### BACKGROUND

Aerosol provision devices and systems are known. Aerosol provision devices and systems include computational systems that are able to obtain information related to the performance of the aerosol provision device/system. The information may be used for reference or for performance purposes. Often this information is retained for the manufacturer. By providing the information to a user, a user may receive better service or greater enjoyment from their device.

Options for providing the information to a user are varied and there are drawbacks associated with the use of applications on mobile devices, particularly in relation to security and privacy.

The present invention is directed toward solving some of the above problems.

### SUMMARY

Aspects of the invention are defined in the accompanying claims.

In accordance with some embodiments described herein, there is provided a stationary communication device for communicating to an aerosol provision device, the stationary communication device comprising: a housing; a communication module housed in the housing, arranged for communication with the aerosol provision device; and, storage for storing data relating to the aerosol provision device.

Such an arrangement is able to provide an improved information delivery system for a user. Such information has previously been used to monitor, learn, and predict end-user “usage” patterns and trends. In the present arrangement, the user is also provided with this information and can therefore interact with the data in different ways. This may be used to improve the usage of the device by the user, or inform how to alter their usage for the benefit of the user. The information may for example be operational data, system data, performance and/or behaviour data.

Specifically, provision of information to a user from a stationary communication device, improves significantly the security of the data provision. The communication device may be allocated to a specific geolocation, such as a user's home or office, and the data related to the user can only be accessed and provided at that predetermined robust and secure location. In this way, access to the information is limited by those that can access the robust and secure location. In turn, access to the information is similarly robust and secure.

An improved social interaction aspect can also be provided to one or more users, as a user can interact with other users on the stationary communication device provided each user is within communicating distance of the secure and robust location in which the stationary communication device is positioned.

The method of communication may be reasonably short range, or low power, to increase the security of access to the stationary communication device.

In accordance with some embodiments described herein, there is provided a system comprising: a stationary communication device; and, an aerosol provision device, wherein the stationary communication device comprises: a housing; a communication device communication module, CDCM, housed in the housing, arranged for communication with the aerosol provision device; and, storage for storing data relating to the aerosol provision device, and wherein the aerosol provision device comprises an aerosol provision device communication module, APDCM, arranged for communication with the stationary communication device.

In accordance with some embodiments described herein, there is provided an arrangement comprising: a stationary communication device; an aerosol provision device; and, a remote delivery server, wherein the stationary communication device comprises: a housing; a communication device communication module, CDCM, housed in the housing, arranged for communication with the aerosol provision device; and, storage for storing data relating to the aerosol provision device, wherein the aerosol provision device comprises an aerosol provision device communication module, APDCM, arranged for communication with the stationary communication device, and wherein the remote delivery server comprises a remote delivery server communication module, RDSCM, arranged for communication with the stationary communication device.

### DESCRIPTION OF DRAWINGS

The present teachings will now be described by way of example only with reference to the following figures:

FIG. 1 is a schematic view of a stationary communication device according to an example;

FIG. 2 is a schematic view of a stationary communication device according to an example;

FIG. 3 is a schematic view of a stationary communication device according to an example;

FIG. 4 is a schematic view of a system according to an example; and,

FIG. 5 is a schematic view of an arrangement according to an example.

While the invention is susceptible to various modifications and alternative forms, specific embodiments are shown by way of example in the drawings and are herein described in detail. It should be understood, however, that the drawings and detailed description of the specific embodiments are not intended to limit the invention to the particular forms disclosed. On the contrary, the invention covers all modifications, equivalents and alternatives falling within the scope of the present invention as defined by the appended claims.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

The present disclosure relates to aerosol provision systems, which may also be referred to as aerosol provision systems, such as e-cigarettes. Throughout the following description the term “e-cigarette” or “electronic cigarette” may sometimes be used, but it will be appreciated this term may be used interchangeably with aerosol provision system/device and electronic aerosol provision system/device. Furthermore, and as is common in the technical field, the terms “aerosol” and “vapour”, and related terms such as “vaporise”, “volatilise” and “aerosolise”, may generally be used interchangeably.

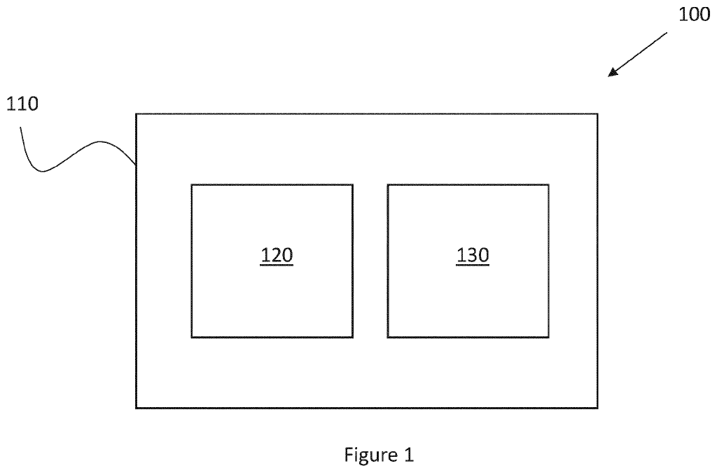

FIG. 1 illustrates a schematic view of an example of a stationary communication device 100 according to the present invention. In an example, the stationary communication device 100 is arranged to communicate with an aerosol provision device. The communication device 100 has a housing 110 and a communication module 120. The communication module 120 is housing in the housing and arranged for communication with aerosol provision devices. The communication device 100 also has storage 130 for storing data relating to aerosol provision devices.

In use, the stationary communication device 100 communicates with an aerosol provision device via the communication module 120. The communication module 120 receives information from the aerosol provision device and this information is stored in the storage 130.

The storage 130 may be memory or the like capable of retaining information received from an aerosol provision device. The data from the aerosol provision device may be any of operational data, system data, performance or behaviour data or the like. The data may comprise at least one of operational data relating to operational details of the aerosol provision device; system data relating to the system details of the aerosol provision device;

wherein the operational data comprises usage data and the system data comprises power management data.

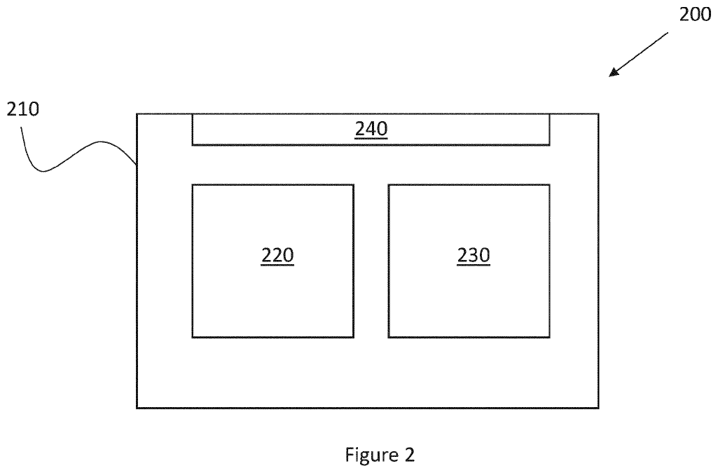

The data is stored in the stationary communication device 100. The information may be presented to the user for interaction with the data. Referring now to FIG. 2, there is shown a schematic view of a stationary communication device 200 according to an example.

The stationary communication device 200 shown in FIG. 2 has features in common with the communication device 100 of FIG. 1. The communication device 200 has a housing 210 communication module 220 and storage 230 for data, for example performance data from an aerosol provision device. The stationary communication device 200 also has a display screen 240 arranged to display data relating to the aerosol provision device to a user.

Via interaction with the display screen 240, the user may access the data communicated to the communication module 200 by an aerosol provision device. In an example, the display screen 240 may comprise a human machine interface, HMI. The user may select to view, and control how to the data is presented via the HMI. In an example, the HMI may be a touchscreen display or the like.

The display screen 240 may provide statistics of use or tracking of progress of use of the aerosol provision device or the like to the user. This means that the user can be provided with meaningful and personalised performance or operational data or the like from the aerosol provision device. In this way, the user can request specific data from the communication stationary device 200, which in turn has originated in the aerosol provision device. The data provided is therefore specifically meaningful to the user as it has been requested. Advantageously the user's experience is improved over systems without such a bespoke provision of data. The user is provided with a greater control over the obtaining of data from the aerosol provision device.

The communication device therefore provides a personalised user “eco-system” wherein the data provided to the user can be tailored to that deemed useful by the user. Indeed, the “home screen” of the stationary communication device 200 displayed on the screen 240 may be personalised to show aerosol provision device-specific data selected by the user. This may be chosen from any list of relevant parameters, including:
total usage time
number of puffs
total capacity of liquid used (in ml e.g.)
battery use
total remaining battery capacity
age of components (e.g. heater or the like)

Each of these may be used by the user to inform their actions. For example, if the screen 240 displays battery capacity (in time or the like) the user may decide to charge their aerosol provision device so as to avoid the battery becoming flat during a desired use period. Similarly, the age of the heater may be used to inform the user when a service of the aerosol provision device is likely to be required. In this way, events that would otherwise interrupt usage (battery running flat, heater breaking) may advantageously avoided. In this way, the user experience of the device is improved.

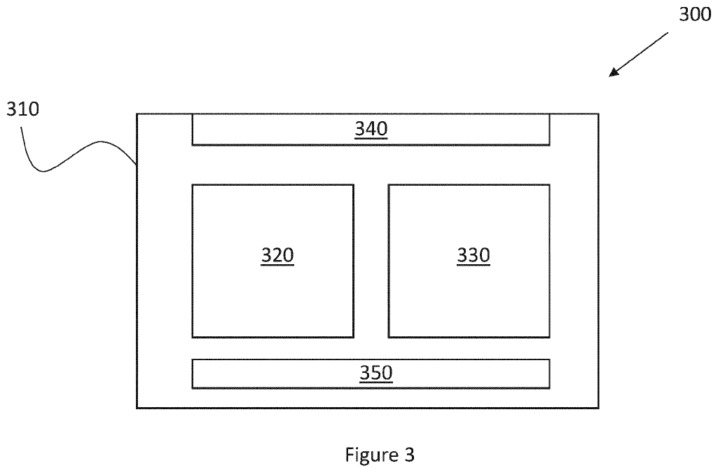

Referring now to FIG. 3, there is shown a schematic view of a stationary communication device 300 according to an example. In the example of FIG. 3, the stationary communication device 300 has a number of features in common with FIGS. 1 and 2. The device 300 has a housing, a communication module 320, storage 330 for storing data, and a display screen 340. The example shown in FIG. 3 also has an authentication module 350. The authentication module 350 may be included in any of the examples described above.

The authentication module 350 is arranged to authenticate an aerosol provision device prior to establishing data communication with the aerosol provision device via the communication module. The authentication module 350 may comprise a communication component and a memory component for comparing data from the aerosol provision device against stored data of known authorised devices. Specifically, the authentication module 350 ascertains the trust level of an aerosol provision device (and the associated user) and then provides functionality from the communication device 300 accordingly.

In the event that the aerosol provision device is recognised as fully trusted (i.e. belongs to an authenticated user), the full functionality of the communication device 300 may be offered to the user. Specifically, the user may have access to the full range of data from their aerosol provision device.

In the event that the aerosol provision device is recognised as partially trusted (i.e. belongs to a user that has partially completed authentication), partial functionality of the communication device 300 may be offered to the user. Specifically, the user may have access to a limited range of data from their aerosol provision device. Primary functions may be offered such as battery level and total usage. Secondary functions, which may include for example an assessment of the health or lifetime of specific components (e.g. heater), may not be offered.

Primary functions and secondary functions may be differentiated by a level of need. For example, the present battery charge of an aerosol provision device is likely to be of more imminent relevance than health of heater. Health of heater relates to the likelihood of a new heater being needed within a predetermined period, while battery life relates to requirement for charge imminently. Primary functions and secondary functions may be differentiated by the level of sophistication required to obtain this data.

Partial authentication of a user may relate to registering an account with the device 300 but not authenticating that device via additional checks which may include one-time alphanumerical passcodes or the like, or the use of photo ID of the user.

In the event that the aerosol provision device is either not recognised or recognised as not trusted, no, or limited, functionality of the communication device 300 may be offered to the user. A lack of recognition may occur when a user has not registered either the aerosol provision device or themselves with the communication device 300. In this event, a user may unlock functionality by registering. In this way, a user can be checked against purchase and age records and the manufacturer can provide a further level of security for an aerosol provision device. The stationary communication device 300 may be able to check a user or an aerosol provision device against purchase records via communication to remote servers.

In an example, the communication module is arranged to communicate to a remote delivery server. While the use data can be provided to a user, data relating to aerosol generating material remaining in the aerosol provision device may be used to inform a user as to when a refill or replacement of aerosol generating material is required or advisable. For example, if an aerosol provision device has only a few puffs remaining of aerosol generating material, the aerosol provision device may provide this information to the communication module of the communication device and this information may be displayed on the display to inform the user. The user may then be able to order replacement aerosol generating material via the communication module which is arranged to communicate to a remote delivery server. The user may be registered with the communication device in such a way that payment is prearranged. The user's experience of reordering is therefore extremely straightforward and only requires recognition of low stock within the aerosol provision device connected to the communication device and then sign off from the user. This sign off or approval from the user may be a simple as interaction with the display screen of the communication device. This may also be performed for components of the aerosol provision device that are in need of replacement, e.g. aged heaters or the like.

In the above example, the user is easily able to order consumable aspects for the aerosol provision device. This may be for aerosol generating material in the form of consumables. The aerosol generating material and/or consumables may be in form of pods or the like for use with the aerosol provision device. The delivery server may be one associated with the manufacturer of the aerosol provision device such that aerosol generating material/consumables purchased are authentic consumables and therefore incompatibility issues (or general quality drawbacks) are prevented. The delivery server may be informed which model of aerosol provision device is requesting the order of new components/consumables. This reduces the likelihood of incompatible consumables being provided (i.e. consumables suitable for a different model being ordered). Again, in this way, the user experience is improved.

The communication device may comprise a detector or sensor for authenticating consumables for use with the aerosol provision device. Specifically, the consumables ordered for the aerosol provision device may be scanned or swiped or docked in the communication device prior to use. During this process a further security level can be provided by unlocking the consumable only following interaction with the communication device. In this way, the user is prevented from using counterfeit products which may provide a substandard aerosol and may damage the aerosol provision device.

The communication device may connect to the aerosol provision device via any communicational methods. Of particular interest are those methods that relate to reasonable distances considering the practicalities involved. Communication over particularly long distances may not be necessary. Bluetooth and Bluetooth Low Energy (or “BLE”) are highly suitable for this purpose as being low energy, reasonably short distance communication. These are highly suitable for a scenario such as installing the communication in a home from within which the user uses the communication device to obtain data from their aerosol provision device.

Other suitable methods include ZigBee; WiFi; Wifi Direct; GSM; 2G; 3G; 4G; 5G; Long Term Evolution, LTE; Near Field Communication, NFC; Ultra Wide Band; or Radio-Frequency Identification, RFID. Each provides a robust and secure communication method that operates over a reasonable distance for the purposes of local recognition of and communication with aerosol provision devices.

Local (i.e. relatively short distance) recognition, as mentioned above, is advantageous to ensure that only the devices of users that are able to access the location in which the stationary communication device is based, can use the features and functions of the stationary communication device. In this way, the security associated with the location is a further security and safety advantage for the stationary communication device. In the example wherein the communication device is in a user's house, using communication that can only reach within the house ensures that potential users must have access to the house. This provides a further security aspect for the communication device against non-authorised users.

In an example, the stationary communication device may have a proximity sensor to detect nearby users or nearby aerosol provision devices or the like. The stationary communication device may not operate until a positive reading for a user or an aerosol provision device is received. The proximity sensor may be a physical sensor, i.e. detecting a physical property of the user or aerosol provision device. In this way, the stationary communication may be protected against hacking attempts towards spoofing the presence of an aerosol provision device.

In an example, the stationary communication device may have a HMI or the like the user may interact directly with prior to accessing the functionality of the communication device. In this way, advantageous further protection against hack attempts can be provided.

The stationary communication device may be stationary in the sense of e.g. having a fixed geolocation, validated in any suitable manner. The geolocation may be validated by a WiFi connection and an assessment of the IP address. Other aspects that indicate the stationary nature of the communication device include for example the device being powered via a wall plug power supply, Such a power supply is robust and reliable and extremely unlikely to cut out or run out.

In an example, the stationary communication device may be used in maintenance of the aerosol provision device. Firmware of the aerosol provision device may be reviewed during communication with the stationary communication device. In the event that the firmware requires updating, the stationary communication device may access the updates and provide these to the aerosol provision device during connection. Such an arrangement may occur overnight, when the aerosol provision device is likely to maintain connection with the stationary communication device over an extended period of time without either needing to be used for other functions. As such, large updates can occur without interruption of the use of the user.

The communication device may be provided with access to manufacturer servers from which such firmware updates may be controlled. The communication device may have authentication from the manufacturer that provides access to firmware updates and the like.

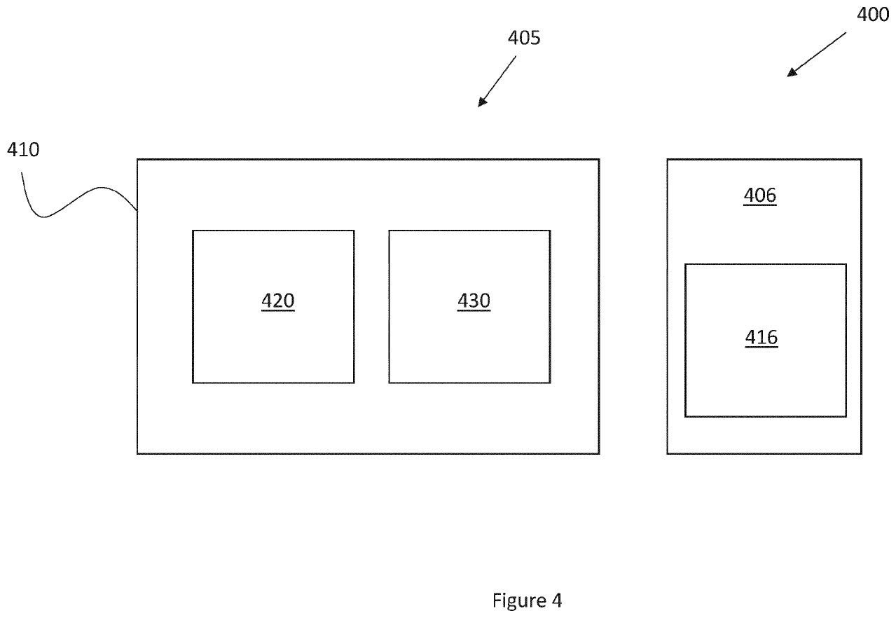

Referring to FIG. 4, there is shown an example of a system 400. The system 400 has a stationary communication device 405 and an aerosol provision device 406. The stationary communication device 405 has a housing 410, a communication device communication module 420 and storage 430. The aerosol provision device 406 has an aerosol provision device communication module 416 arranged for communication with the communication device 405. The stationary communication device 405 and the aerosol provision device 406 are able to communicate via the respective communication modules 420, 416.

In an example, the communication device 405 further comprises an authentication module arranged to authenticate the aerosol provision device 406 prior to establishing data communication with the aerosol provision device 406. In this way, secure communication occurs between the communication device 405 and an authorised user (owning an authorised aerosol provision device 406).

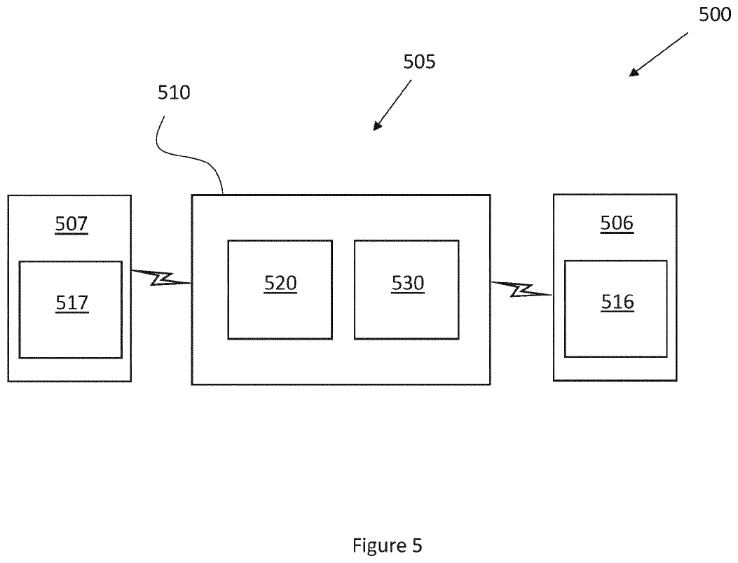

Referring to FIG. 5, there is shown an example of an arrangement 500. The arrangement 500 has a stationary communication device 505, an aerosol provision device 506 and a remote delivery server 507. The stationary communication device 505 has a housing 510, a communication device communication module, CDCM, 520 and storage 530 for storing data relating to the aerosol provision device 506. The aerosol provision device 506 has an aerosol provision device communication module, APDCM, 516. The remote delivery server 507 comprises a remote delivery server communication module, RDSCM, 517.

In use, the communication device 505 communicates with the aerosol provision device 506. This may occur via the CDCM 520 communicating with the APDCM 516. Information relating to the aerosol provision device 506 may be viewed by a user on the stationary communication device 505. The stationary communication device 505 may communicate with the remote delivery server 507 to reorder consumables or the like as described above. Specifically, the communication may occur via the CDCM 520 communicating with the RPDCM 517.

The aerosol provision device 506 may be a tobacco heating product or vape device or the like. The aerosol provision device 506 may use Bluetooth or similar communication methods. The aerosol provision device 506 may connect to and communicate through multiple stationary communication devices 505. Similarly, multiple aerosol provision devices may connect to one stationary communication device 505. The flexibility of this relates to the distance over which the communication method operates, e.g. a short communication distance increases the likelihood of one to one pairing; this stems from the unlikeliness of multiple stationary communication devices 505 occupying very similar locations.

The aerosol provision device 506 may provide device usage data to the stationary communication device 506. The stationary communication device 506 may provide firmware updates or device configuration or the like. This may be requested by the manufacturer to be provided to user via the communication device 506. In this way, the communication device 506 can provide a further of level of control for the manufacturer over the distribution of legitimate firmware updates. The communication device 506 may reduce the likelihood of success of hack attempts or the like.

This arrangement 500 provides a stationary communication device 505 that may be low cost, and Bluetooth and WiFi enabled. The connection to the aerosol provision device 506 may be via Bluetooth, or the like, while the connection to the server 507 may be via Wi-Fi. The communication device 505 may connect to the manufacture's cloud via Wi-Fi.

As such, there is disclosed herein a reliable, robust, communication device for providing a user with information obtained from an aerosol provision device. The communication device has improved safety and reliability over previously existing systems. The communication device may process consumption habits of a user and provide for replacement consumables to be obtained. The consumables purchased may be known authentic consumables. The communication device therefore improves the user experience while simultaneously reducing the likelihood of un-authentic consumables being used, thereby mitigating against poor performance or degradation of the aerosol provision device via use of uncontrolled aerosol generating material.

In a particular example, the device disclosed herein may operate with a flavour pod which is replaceable in the device—this may be referred to as a consumable. The flavour may be any of tobacco and glycol and may include extracts (e.g., licorice, hydrangea, Japanese white bark magnolia leaf, chamomile, fenugreek, clove, menthol, Japanese mint, aniseed, cinnamon, herb, wintergreen, cherry, berry, peach, apple, Drambuie, bourbon, scotch, whiskey, spearmint, peppermint, lavender, cardamon, celery, cascarilla, nutmeg, sandalwood, bergamot, geranium, honey essence, rose oil, vanilla, lemon oil, orange oil, cassia, caraway, cognac, jasmine, ylang-ylang, sage, fennel, piment, ginger, anise, coriander, coffee, or a mint oil from any species of the genus Mentha), flavour enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof.

When combined with an aerosol generating medium, the aerosol provision device as disclosed herein may be referred to as an aerosol provision system.

Thus there has been described an aerosol provision device, for providing an aerosol for inhalation by a user, comprising: control circuitry for controlling an activation state of the aerosol provision device; a detector arranged to detect an air output associated with a user of the aerosol provision device; wherein the control circuitry is arranged to update an activation state of the aerosol provision device in response to receiving a signal from the detector associated with an authorised user.

The aerosol provision system may be used in a tobacco industry product, for example a non-combustible aerosol provision system.

In one embodiment, the tobacco industry product comprises one or more components of a non-combustible aerosol provision system, such as a heater and an aerosolizable substrate.

In one embodiment, the aerosol provision system is an electronic cigarette also known as a vaping device.

In one embodiment the electronic cigarette comprises a heater, a power supply capable of supplying power to the heater, an aerosolizable substrate such as a liquid or gel, a housing and optionally a mouthpiece.

In one embodiment the aerosolizable substrate is contained in or on a substrate container. In one embodiment the substrate container is combined with or comprises the heater.

In one embodiment, the tobacco industry product is a heating product which releases one or more compounds by heating, but not burning, a substrate material. The substrate material is an aerosolizable material which may be for example tobacco or other non-tobacco products, which may or may not contain nicotine. In one embodiment, the heating device product is a tobacco heating product.

In one embodiment, the heating product is an electronic device.

In one embodiment, the tobacco heating product comprises a heater, a power supply capable of supplying power to the heater, an aerosolizable substrate such as a solid or gel material.

In one embodiment the heating product is a non-electronic article.

In one embodiment the heating product comprises an aerosolizable substrate such as a solid or gel material, and a heat source which is capable of supplying heat energy to the aerosolizable substrate without any electronic means, such as by burning a combustion material, such as charcoal.

In one embodiment the heating product also comprises a filter capable of filtering the aerosol generated by heating the aerosolizable substrate.

In some embodiments the aerosolizable substrate material may comprise an aerosol or aerosol generating agent or a humectant, such as glycerol, propylene glycol, triacetin or diethylene glycol.

In one embodiment, the tobacco industry product is a hybrid system to generate aerosol by heating, but not burning, a combination of substrate materials. The substrate materials may comprise for example solid, liquid or gel which may or may not contain nicotine. In one embodiment, the hybrid system comprises a liquid or gel substrate and a solid substrate. The solid substrate may be for example tobacco or other non-tobacco products, which may or may not contain nicotine. In one embodiment, the hybrid system comprises a liquid or gel substrate and tobacco.

In order to address various issues and advance the art, the entirety of this disclosure shows by way of illustration various embodiments in which the claimed invention(s) may be practiced and provide for a superior electronic aerosol provision system. The advantages and features of the disclosure are of a representative sample of embodiments only, and are not exhaustive and/or exclusive. They are presented only to assist in understanding and teach the claimed features. It is to be understood that advantages, embodiments, examples, functions, features, structures, and/or other aspects of the disclosure are not to be considered limitations on the disclosure as defined by the claims or limitations on equivalents to the claims, and that other embodiments may be utilised and modifications may be made without departing from the scope and/or spirit of the disclosure. Various embodiments may suitably comprise, consist of, or consist essentially of, various combinations of the disclosed elements, components, features, parts, steps, means, etc. In addition, the disclosure includes other inventions not presently claimed, but which may be claimed in future.

1. A stationary communication device for communicating to an aerosol provision device, the stationary communication device comprising:
a housing;
a communication module housed in the housing, arranged for communication with the aerosol provision device; and,
storage for storing data relating to the aerosol provision device.

2. A stationary communication device according to claim 1, wherein the stationary communication device comprises an authentication module arranged to authenticate an aerosol provision device prior to establishing data communication with the aerosol provision device via the communication module.

3. A stationary communication device according to claim wherein the communication module is arranged to receive data from the aerosol provision device, the data comprising at least one of:
operational data relating to operational details of the aerosol provision device;
system data relating to the system details of the aerosol provision device;
wherein the operational data comprises usage data and the system data comprises power management data.

4. A stationary communication device according to claim 1, further comprising a display screen arranged to display data relating to the aerosol provision device to a user.

5. A stationary communication device according to claim 4, wherein the display screen comprises a human machine interface.

6. A stationary communication device according to claim 1, wherein the communication module is further arranged to communicate to a remote delivery server.

7. A stationary communication device according to claim 1, wherein the communication module is arranged to communicate via at least one: Bluetooth; Bluetooth Low Energy, BLE; ZigBee; WiFi; Wifi Direct; GSM; 2G, 3G, 4G; 5G; Long Term Evolution, LTE; Near Field Communication, NFC; Ultra Wide Band; or Radio-Frequency Identification, RFID.

8. A system comprising:
a stationary communication device; and,
an aerosol provision device,
wherein the stationary communication device comprises:
a housing;
a communication device communication module, CDCM, housed in the housing, arranged for communication with the aerosol provision device; and,
storage for storing data relating to the aerosol provision device,
and wherein the aerosol provision device comprises an aerosol provision device communication module, APDCM, arranged for communication with the stationary communication device.

9. A system according to claim 8, wherein the stationary communication device further comprises an authentication module arranged to authenticate the aerosol provision device prior to establishing data communication with the aerosol provision device via communication between the CDCM and the APDCM.

10. A system according to claim 8, wherein the CDCM is arranged to receive data from the APDCM, the data comprising at least one of:
operational data relating to operational details of the aerosol provision device;
system data relating to the system details of the aerosol provision device;
wherein the operational data comprises usage data and the system data comprises power management data.

11. A system according to claim 8, wherein the stationary communication device further comprises a display screen arranged to display data received from the aerosol provision device to a user.

12. A system according to claim 8, wherein the CDCM is further arranged to communicate to a remote delivery server.

13. A system according to claim 8, wherein the CDCM and APDCM are arranged to communicate via at least one: Bluetooth; Bluetooth Low Energy; ZigBee, WiFi; Wifi Direct; GSM; 2G; 3G; 4G; 5G; Long Term Evolution, LTE; Near Field Communication, NFC; Ultra Wide Band; or Radio-Frequency Identification, RFID.

14. An arrangement comprising:
a stationary communication device;
an aerosol provision device; and,
a remote delivery server,
wherein the stationary communication device comprises:
a housing;
a communication device communication module, CDCM, housed in the housing, arranged for communication with the aerosol provision device; and,
storage for storing data relating to the aerosol provision device,
wherein the aerosol provision device comprises an aerosol provision device communication module, APDCM, arranged for communication with the stationary communication device, and
wherein the remote delivery server comprises a remote delivery server communication module, RDSCM, arranged for communication with the stationary communication device.

15. An arrangement according to claim 14, wherein the stationary communication device further comprises an authentication module arranged to authenticate the aerosol provision device prior to establishing data communication with the aerosol provision device via communication between the CDCM and the APDCM.

16. An arrangement according to claim 14, wherein the CDCM is arranged to receive data from the APDCM, the data comprising at least one of:
operational data relating to operational details of the aerosol provision device;
system data relating to the system details of the aerosol provision device;
wherein the operational data comprises usage data and the system data comprises power management data.

17. An arrangement according to claim 14, wherein the stationary communication device further comprises a display screen arranged to display data received from the aerosol provision device to a user.

18. An arrangement according to claim 14, wherein the CDCM is further arranged to communicate to the remote delivery server,
the remote delivery server arranged to supply a consumable for the aerosol provision device in response to a request message from the CDCM.

19. An arrangement according to claim 14, wherein the CDCM, APDCM and RDSCM are arranged to communicate via at least one: Bluetooth; Bluetooth Low Energy; ZigBee, WiFi; Wifi Direct; GSM; 2G; 3G; 4G; 5G; Long Term Evolution, LTE; Near Field Communication, NFC; Ultra Wide Band; or Radio-Frequency Identification, RFID.
